(19) United States
(12) Patent Application Publication
(10) Pub. No.: US 2020/0386549 A1
(43) Pub. Date: Dec. 10, 2020

(54) SURVEYING INSTRUMENT SHARING SYSTEM AND METHOD FOR SHARING SURVEYING INSTRUMENT

(71) Applicant: TOPCON CORPORATION, Tokyo (JP)

(72) Inventor: Takeshi KIKUCHI, Tokyo (JP)

(21) Appl. No.: 16/886,211

(22) Filed: May 28, 2020

(30) Foreign Application Priority Data
Jun. 7, 2019 (JP) 2019-107203

(51) Int. Cl. G01C 15/06; G06F 21/31; G06Q 30/06

(52) U.S. Cl. CPC G01C 15/06; G06Q 30/0645; G06F 21/31

(57) ABSTRACT

Provided is a surveying instrument sharing system including a surveying instrument and a management server, capable of communicating with each other, the management server includes a personal identification information database having authentication information registered in advance and a use management table as a correspondence table between information on available surveying instruments and the required number of points, the surveying instrument includes a personal authentication execution unit that identifies a user from the personal identification information database based on authentication data acquired by a personal authentication sensor, the management server includes an availability determination unit that determines whether the surveying instrument is available to an identified user based on the use management table, and a point consumption unit that consumes the required number of points from points that the identified user purchased in advance based on the use management table, and the surveying instrument is made available by consumption of points.

### CROSS-REFERENCE TO RELATED APPLICATION

The present application claims priority under 35 U.S.C. § 119 to Japanese Patent Application No. 2019-107203 filed Jun. 7, 2019. The contents of this application are incorporated herein by reference in their entirely.

### FIELD OF THE INVENTION

The present invention relates to a surveying instrument sharing system and a method for sharing a surveying instrument, and more specifically, to a surveying instrument sharing system and a method for sharing a surveying instrument, using a communication management system for a surveying instrument.

### BACKGROUND

Conventionally, many proposals have been made to remotely manage a surveying instrument through a communication network such as the internet.

For example, JP2007-170978A discloses a communication management system for a surveying instrument, which grasps a state of a surveying instrument through a communication network to manage a license term and a maintenance period, etc.

In recent years, communication management systems for surveying instrument have been increasingly developed, and various functions have become available. Such communication management systems are based on the premise that one user owns or leases at least one surveying instrument. Meanwhile, surveying instruments are expensive.

Therefore, instead of owning a surveying instrument, construction of a system enabling a surveying instrument to be shared by multiple persons has been required.

### SUMMARY OF THE INVENTION

However, when sharing a surveying instrument with multiple people, it is necessary to manage in detail such as who is using it and when. Also, it is necessary to manage costs so that cost-sharing is transparent. Therefore, a problem occurs in which management becomes complicated.

The present invention was made in view of the above-described circumstances, and an object thereof is to provide a surveying instrument sharing system and a method for sharing a surveying instrument, which do not require complicated management, and enable a user to use a surveying instrument without ownership.

In order to achieve the above-described object, a surveying instrument sharing system according to an aspect of the present invention includes a surveying instrument including a measuring unit configured to make measurements for a survey, a communication unit, a personal authentication sensor, and a control unit, and a management server including a server storage unit, a server communication unit, and a server control unit, and capable of communicating with the surveying instrument through a communication network, wherein the server storage unit includes a personal identification information database having authentication information registered in advance, and a use management table as a correspondence table between information on available surveying instruments and the required number of points, the control unit of the surveying instrument includes a personal authentication execution unit configured to identify a user from the personal identification information database based on authentication data acquired by the personal authentication sensor, the server control unit includes an availability determination unit configured to determine whether the surveying instrument is available to an identified user based on the use management table, and a point consumption unit configured to consume the required number of points from points purchased in advance by the identified user based on the use management table, and the surveying instrument is made available by consumption of the points.

In the aspect described above, it is also preferable that the control unit of the surveying instrument further includes a use condition settings unit for setting a condition specified by the identified user, and the availability determination unit determines whether the surveying instrument is available under the specified condition set in the use condition settings unit based on the use management table.

In the aspect described above, it is also preferable that the availability determination unit determines whether the surveying instrument is available based on a predetermined condition.

In the aspect described above, it is also preferable that the control unit of the surveying instrument further includes a use state check unit configured to check whether the surveying instrument has already become available to the identified user.

A method for sharing a surveying instrument according to another aspect of the present invention includes a step of identifying a user by a control unit of a surveying instrument including a measuring unit configured to make measurements for a survey, a communication unit, a personal authentication sensor, and a control unit, from a personal identification information database having authentication information registered in advance in a management server capable of communicating with the surveying instrument through a communication network based on authentication data acquired by the personal authentication sensor, and a step of making available the surveying instrument by consuming the required number of points for use of the surveying instrument by the control unit from points that the identified user purchased in advance in a case where the surveying instrument is determined to be available as a result of determination as to whether the surveying instrument is available to the identified user made by the management server based on a use management table as a correspondence table between information on available surveying instruments and the required number of points.

### BENEFIT OF THE INVENTION

According to the above-described aspects of the present invention, a surveying instrument sharing system and a method for sharing a surveying instrument which do not require complicated management and enable a user to utilize a surveying instrument without ownership, are provided.

### BRIEF DESCRIPTION OF THE DRAWINGS

FIG. 1 is an entire configuration diagram of a surveying instrument sharing system according to an embodiment of the present invention.

FIG. 2 is a configuration block diagram of a surveying instrument according to the same embodiment.

FIG. 3 is a configuration block diagram of a remote terminal according to the same embodiment.

FIG. 4 is a configuration block diagram of a management server according to the same embodiment.

FIG. 5 is a diagram illustrating an example of a use management table in the sharing system of the same embodiment.

FIG. 6 is a flowchart of processing for pre-registration in the sharing system of the same embodiment.

FIG. 7 is a flowchart of processing when purchasing points in the same sharing system.

FIG. 8 is a flowchart of processing at the start of use of a surveying instrument in the same sharing system.

FIG. 9 is a detailed flowchart of personal authentication at the start of use of the same surveying instrument.

FIG. 10 is a flowchart of processing for availability determination by a management server at the start of use of the same surveying instrument.

FIG. 11 is a flowchart of processing for availability determination by a management server in a sharing system according to Modification 3 of the same embodiment.

### DESCRIPTION OF EMBODIMENT(S)

Hereinafter, preferred embodiments of the present invention will be described with reference to the drawings, however, the present invention is not limited to these. In each modification, only different configurations and processing are described, and overlapping description is omitted.

### Embodiments

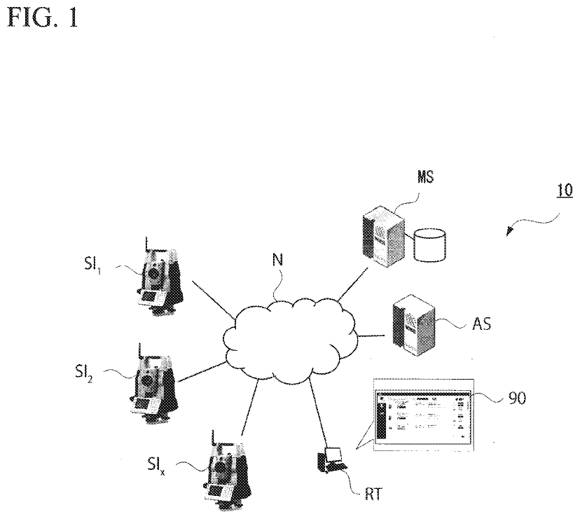

FIG. 1 is a diagram illustrating an entire configuration of a surveying instrument sharing system (hereinafter, simply referred to as “system” as well) 10 according to an embodiment. The system 10 includes a plurality of surveying instruments SI₁, SI₂, . . . SIₓ as use objects, a remote terminal RT, a management server MS, and an accounting system AS. As illustrated in FIG. 1, the system 10 may include a plurality of surveying instruments SI₁, SI₂, . . . SIₓ as use objects. However, the following description is given about one surveying instrument SI₁ as a current use object.

The surveying instrument SI₁, the remote terminal RT, the management server MS, and the accounting system AS are configured to be capable of communicating with each other through a communication network N, for example, the internet, a satellite communication network, etc.

### Configuration of Surveying Instrument

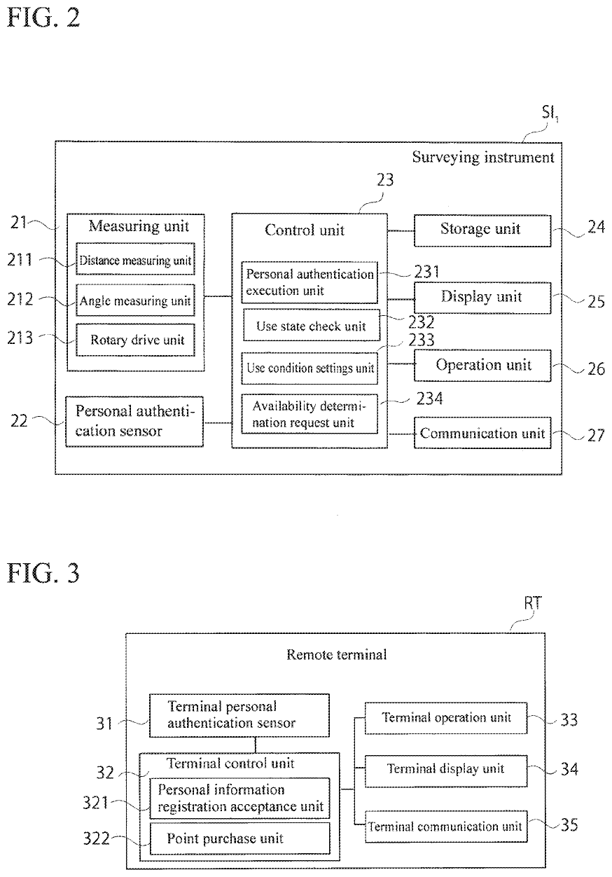

FIG. 2 is a configuration block diagram of the surveying instrument SI₁. Here, the surveying instrument SI₁ is a total station. However, the surveying instruments SI₁, SI₂, . . . SIₓ as objects to be managed are not limited to total stations, and may be various devices to be used for surveying, such as transits, electronic levels, and GPS devices.

The surveying instrument SI₁ includes a measuring unit 21, a personal authentication sensor 22, a control unit 23, a storage unit 24, a display unit 25, an operation unit 26, and a communication unit 27.

The measuring unit 21 includes a known configuration to enable the total station to measure a distance and an angle to a target. Specifically, the measuring unit 21 includes a distance measuring unit 211, an angle measuring unit 212, and a rotary drive unit 213.

The distance measuring unit 211 includes a light emitting element, a distance measuring optical system, and a light receiving element disposed inside a telescope (not illustrated). The distance measuring unit 211 emits distance measuring light from the light emitting element through the distance measuring optical system and irradiates a target, and measures a distance to the target by receiving reflected light from the target by the light receiving element.

The angle measuring unit 212 measures a horizontal angle and a vertical angle to the target by measuring a vertical rotation angle of the telescope and a horizontal rotation angle of a bracket portion by rotary encoders (not illustrated) disposed at the respective rotation angles.

The rotary drive unit 213 includes a motor and drives the respective rotary shaft of the telescope and the bracket portion according to control of the control unit 23.

An example of the personal authentication sensor 22 is a non-contact type ID reader (Radio Frequency Identifier) or a biometric authentication sensor, such as fingerprint sensor, iris sensor, vein sensor, etc. The personal authentication sensor is disposed in an appropriate form on an outer surface of the surveying instrument SI₁. A plurality of different types of personal authentication sensors may be equipped.

The control unit 23 is a control unit including at least a CPU and a memory (RAM, ROM, etc.) on an integrated circuit. The measuring unit 21, the personal authentication sensor 22, the storage unit 24, the display unit 25, the operation unit 26, and the communication unit 27 are connected to the control unit 23.

The control unit 23 executes applications of various functions, and makes a measurement by controlling the measuring unit 21.

The control unit 23 includes, as functional units, a personal authentication execution unit 231, a use state check unit 232, a use condition settings unit 233, and an availability determination request unit 234.

The personal authentication execution unit 231 drives the personal authentication sensor 22 and accepts authentication data, and executes personal authentication by checking the authentication data against a personal identification information database stored in the management server MS.

The use state check unit 232 determines whether the authenticated user is in a use state of using the surveying instrument SI₁ by referring to a use management table in the management server MS.

The use condition settings unit 233 displays a screen that enables the authenticated user for setting conditions for use of the surveying instrument SI₁ on the display unit 25, and the user performs settings. As a use condition, for example, a period of use and an available time zone, etc., can be specified.

The availability determination request unit 234 requests the management server MS to determine availability based on the user's specified condition.

The storage unit 24 consists of a storage medium, for example, a memory card, HDD (Hard Disc Drive), etc. The storage unit 24 stores programs for execution of applications of various functions. The storage unit 24 also stores a distance measurement value measured by the distance measuring unit 211, an angle measurement value measured by the angle measuring unit 212, and various information acquired by the control unit 23 together with dates and times of occurrence.

The display unit 25 is, for example, a liquid crystal display. The display unit 25 displays a screen for an operation according to an application. Settings for executing the application can be input from the operation unit 26.

The communication unit 27 enables the control unit 23 to transmit and receive data to and from the management server MS through the communication network N.

As described above, the surveying instrument SI₁ is not limited to a total station, and may be various devices to be used for surveying, such as a transit, an electronic level, a GPS device, a scanner device, etc. In this case, the measuring unit 21 is not limited to the above-described configuration, but has a known configuration corresponding to functions of the devices.

### Configuration of Remote Terminal

As illustrated in FIG. 3, the remote terminal RT is a terminal such as a personal computer, a smartphone, or a tablet of a user who intends to use the surveying instrument SI₁ or an administrator of the user. The remote terminal RT includes a terminal personal authentication sensor 31, a terminal control unit 32, a terminal operation unit 33, a terminal display unit 34, and a terminal communication unit 35.

The terminal personal authentication sensor 31 has a configuration and functions equivalent to those of the personal authentication sensor 22 equipped in the surveying instrument SI₁.

The terminal control unit 32 is a control unit includes at least a CPU and a memory (RAM, ROM, etc.) on an integrated circuit. The terminal control unit 32 is connected to each of the terminal personal authentication sensor 31, the terminal operation unit 33, the terminal display unit 34, and the terminal communication unit 35.

The terminal control unit 32 includes, as functional units, a personal information registration acceptance unit (hereinafter, referred to as “registration acceptance unit”) 321 and a point purchase unit 322. The registration acceptance unit 321 functions when pre-registering authentication information. The registration acceptance unit 321 associates user information with personal authentication information (ID number or biological information such as fingerprint, iris, vein, etc.) and transmits these to the management server MS. The point purchase unit 322 creates accounting data corresponding to the number of points according to a point purchase command from the user and transmits the data to the accounting system AS, and checks whether payment is possible.

The terminal operation unit 33 is an input device for the terminal, for example, a keyboard, a mouse, etc., and inputs information required for user registration.

The terminal display unit 34 is, for example, a liquid crystal display, and displays a webpage 90 required for registration of authentication information according to control of the terminal control unit 32.

The terminal communication unit 35 enables information transmission and reception to and from the server communication unit 41 of the management server MS through the communication network N.

### Configuration of Management Server

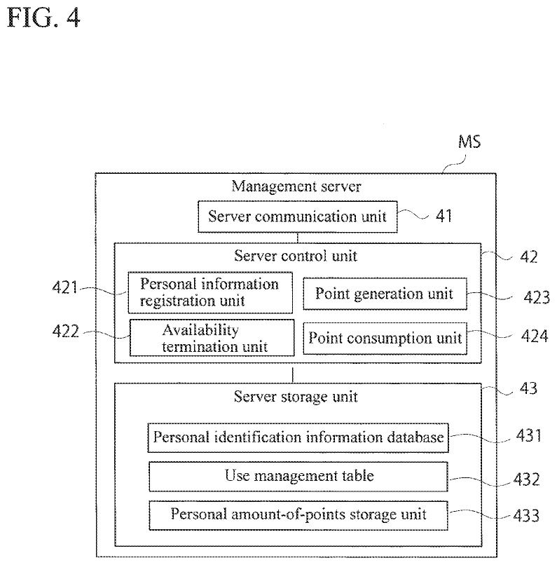

The management server MS includes, as illustrated in FIG. 4, a server communication unit 41, a server control unit 42, and a server storage unit 43.

The server communication unit 41 enables data transmission and reception to and from the communication unit 27 of the surveying instrument SI₁, the terminal communication unit 35 of the remote terminal RT, and the accounting system AS through the communication network N.

The server control unit 42 is a control unit including at least a CPU and a memory (RAM, ROM, etc.) on an integrated circuit. The server control unit 42 is connected to the server communication unit 41 and the server storage unit 43.

The server control unit 42 includes, as functional units, a personal information registration unit 421, an availability determination unit 422, a point generation unit 423, and a point consumption unit 424.

The personal information registration unit 421 associates user information with personal authentication information (ID number or biological information such as fingerprint, iris, vein, etc.) received from the surveying instrument SI₁, and stores these in a personal identification information database (hereinafter, referred to as “identification information database”) 431.

The availability determination unit 422 determines whether the surveying instrument SI₁ is available under a use condition specified by the user based on the data received from the surveying instrument SI₁ and a use management table described later, and gives an answer to the surveying instrument SI₁.

The point generation unit 423 generates points in the form of exchange for currency, such as yen and dollar, on a request from the remote terminal RT, and stores the amount of points in a personal amount-of-points storage unit 433.

The point consumption unit 422 consumes points required for use of the surveying instrument SI₁ under the specified condition when the surveying instrument SI₁ is determined to be available according to determination by the availability determination unit 422.

Here, the points have a value corresponding to monetary value with respect to a service to be provided from the system 10, and may have exchange value so as to be converted into cash and used for other services. A user can purchase points by, for example, withdrawal from a bank account, payment by credit card, or using electronic money that the user owns.

The accounting data is data required for payment, and includes, for example, a bank account number or a credit card number, and a purchased amount, etc.

The server storage unit 43 is a storage medium such as a large-capacity HDD, and includes at least a personal identification information database (hereinafter, referred to as “identification information database”) 431, a use management table 432, and a personal amount-of-points storage unit 433.

In the personal identification information database 431, the user registration information and personal authentication information (ID number or biological information such as fingerprint, iris, vein, etc.) acquired in the personal information registration acceptance unit 321 of the remote terminal RT and received by the management server MS from the remote terminal RT are stored in association with each other.

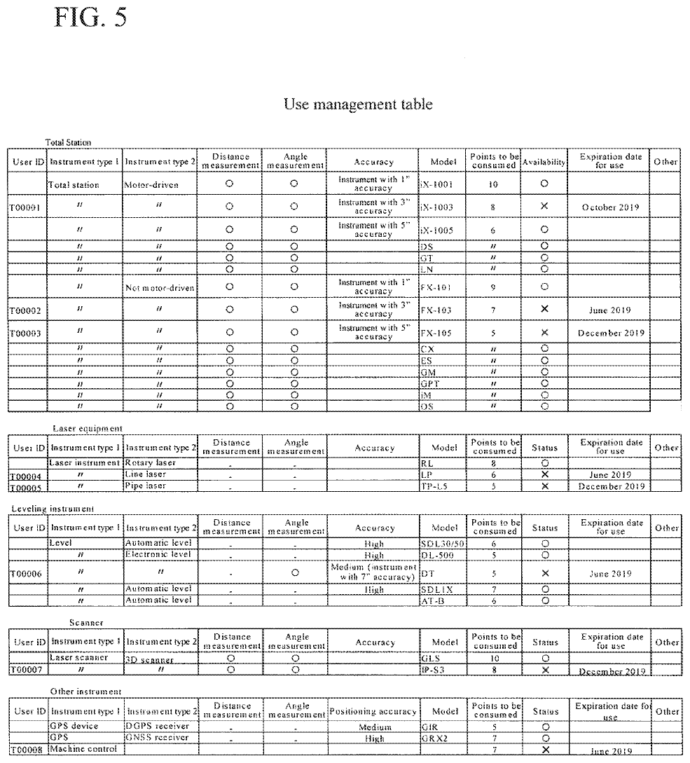

The use management table 432 includes information on available instruments in the system 10 and the number of points to be consumed for use of the respective instruments for a predetermined period of time are stored in association with each other. FIG. 5 illustrates an example of the use management table 432. In FIG. 5, as information on each available instruments, a current user ID, the type, functions, performance, the model, current availability of the surveying instrument, and an expiration date for use in a case where the instrument is being used, are described, and are associated with the number of points to be consumed for use of the surveying instrument for one month.

As illustrated in FIG. 5, the number of points to be consumed may be set as appropriate according to the type of the surveying instrument and performance of the surveying instrument. The number of points to be consumed and the expiration date for use may be set not only on a monthly basis but also on a daily or hourly basis.

The personal amount-of-points storage unit 433 stores the amount of points that a user holds for each user.

### Configuration of Accounting System

The accounting system AS is a system to make payment based on accounting data corresponding to the amount of points transmitted from the management server MS. The accounting system AS is realized by a computer, and this is a known technology, so that detailed description is omitted. The accounting system AS may be incorporated in the management server MS.

### Operation of System

Hereinafter, operation of the system 10 when the system 10 is used is described. For use of the system 10, a manufacturer or agent of a surveying instrument provides a webpage 90 for providing services. A user acquires a user account by pre-registration, and uses the system 10.

### Pre-Registration

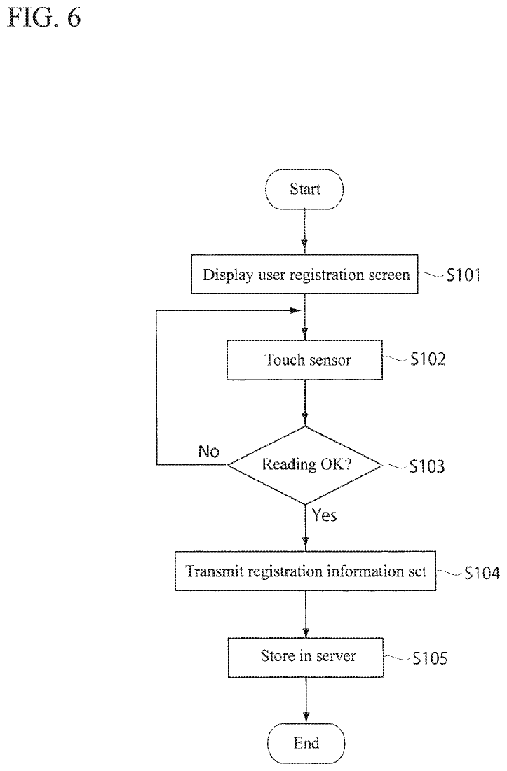

FIG. 6 is a flowchart of processing for pre-registration for use of the system 10. In the following description, a case of using fingerprint authentication is described by way of example, however, a configuration can be made so as to use authentication data adapted to the type of the personal authentication sensor.

In the system 10, pre-registration of user information is performed with the remote terminal RT.

In the remote terminal RT, when a pre-registration program is executed, in Step S101, the registration acceptance unit 321 displays a screen for user registration on the terminal display unit 34. The registration acceptance unit 321 requests the user to input user information, for example, a personal name, an e-mail address, a log-in password, etc.

When the user finishes inputs, in Step S102, the registration acceptance unit 321 displays a screen for urging the user to touch and place a fingerprint on the terminal personal authentication sensor 31, on the terminal display unit 34.

Next, in Step S103, the registration acceptance unit 321 checks whether the terminal personal authentication sensor 31 has successfully read the authentication data. When the data is successfully read (Yes), the processing shifts to Step 5104. When reading fails (No), the processing returns to Step S102.

In Step S104, the registration acceptance unit 321 associates the user information input in Step S101 with the authentication information read in Step S103 to transmit these as a set of registration information to the management server MS. Next, in Step S105, the management server MS stores the received set of the user information and the authentication information in the identification information database 431, and ends the pre-registration.

### Point Purchase

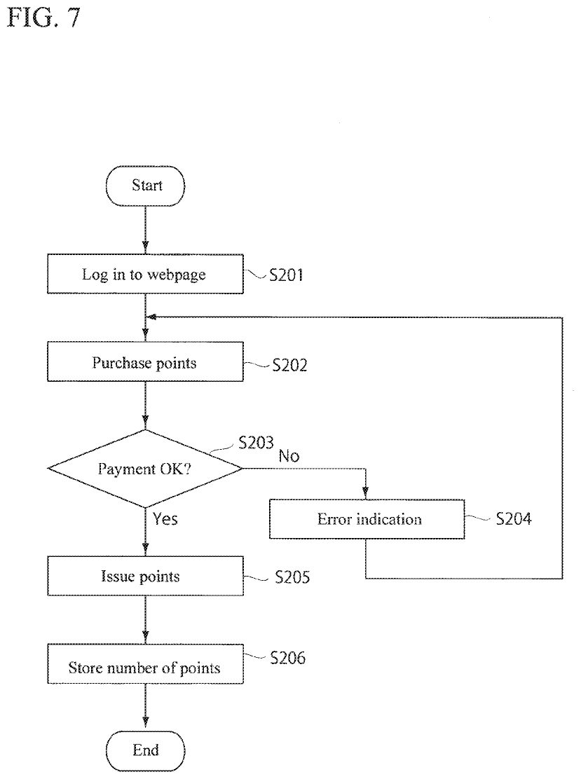

FIG. 7 is a flowchart of processing when purchasing points for use of the system 10.

When starting the processing, in Step S201, the user logs in to his/her own user account from the webpage 90 displayed on the terminal display unit 34.

Next, in Step S202, the user purchases points by inputting the number of points and a payment method on the webpage 90. When point purchase information is input, in Step S203, the point purchase unit 322 of the terminal control unit 32 creates accounting data corresponding to the number of points and transmits the data to the accounting system AS, and checks whether payment is possible.

In Step S203, when the accounting system AS gives an answer that the payment is not possible (No), an error indication is displayed on the terminal display unit 34, and the processing returns to Step S202. When the accounting system AS gives an answer that the payment is possible (Yes), in Step S205, the point generation unit 423 generates (issues) the specified number of points, and in Step S206, associates the number of points with the user and stores them in the personal amount-of-points storage unit 433, and ends the processing.

### Processing When Using Instrument

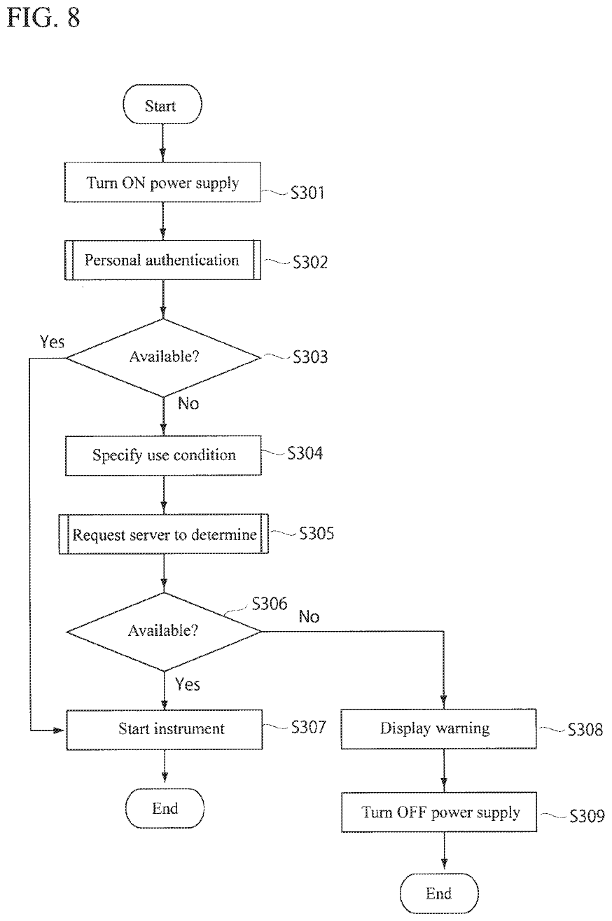

FIG. 8 is a flowchart of processing when the user uses the surveying instrument SI₁ by using the system 10.

When the user turns ON a power supply of the surveying instrument SI₁ in Step S301, the personal authentication execution unit 231 starts personal authentication in Step S302.

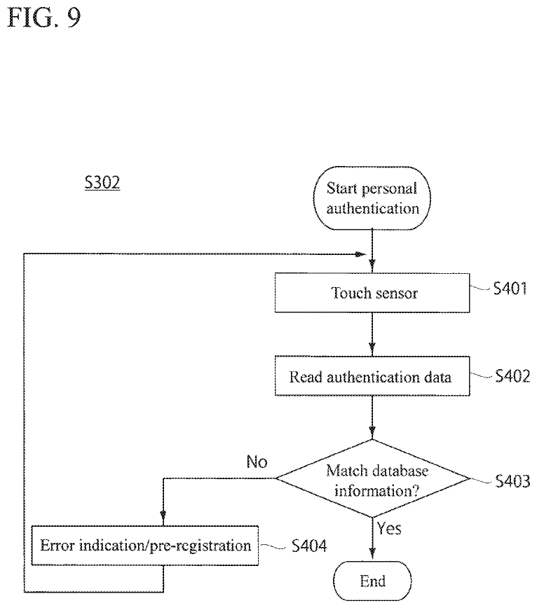

FIG. 9 is a detailed flowchart of personal authentication in Step S302.

When personal authentication is started, in Step S401, the personal authentication execution unit 231 displays a screen for urging the user to touch and place a fingerprint on the personal authentication sensor 22, on the display unit 25. Alternatively, a configuration may be made so that, in Step S301 and Step S401, when the user performs an action at the personal authentication sensor 22, the power supply of the surveying instrument SI₁ is automatically turned on, and the personal authentication execution unit 231 starts personal authentication.

Next, in Step S402, the personal authentication execution unit 231 reads authentication data from the personal authentication sensor 22.

Next, in Step S403, through the communication unit 27, the personal authentication execution unit 231 determines whether the authentication data matches personal authentication information of the user stored in the identification information database 431 of the management server MS.

When they do not match (No), in Step S404, the personal authentication execution unit 231 displays an error indication and a request for pre-registration as required on the display unit 25, and the processing returns to Step S401.

On the other hand, in a case of match (Yes), the personal authentication is ended, and the processing shifts to Step S303.

Next, in Step S303, the use state check unit 232 determines whether the surveying instrument SI₁ has currently become available to the user with reference to the use management table 432 of the server MS.

When the surveying instrument SI₁ is not available (No), in Step S304, the use condition settings unit 233 displays a screen enabling the user to specify at least a period of use as a condition on the display unit 25. When the user inputs a use condition (a period of use), the processing shifts to Step S305.

In Step S305, the availability determination request unit 234 transmits its own instrument information, ID information of the user, and the period of use specified by the user to the management server MS, and requests checking availability.

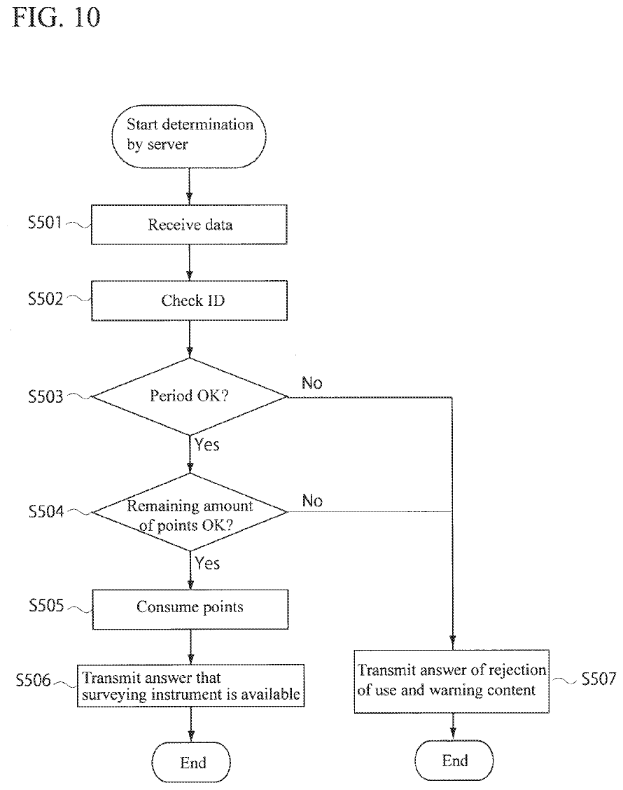

FIG. 10 is a flowchart of processing of the management server MS when a request for determination of availability is made from the surveying instrument SI₁.

In Step S501, when the management server MS receives the instrument information, the ID information of the user, and information on the period of use requested by the user from the surveying instrument SI₁, in Step S502, the availability determination unit 422 refers to the use management table 432 stored in the server storage unit 43.

Next, in Step S503, the availability determination unit 422 determines whether the surveying instrument SI₁ is available for the period of use specified by the user.

When the surveying instrument SI₁ is available for the specified period of use (Yes), in Step S504, the availability determination unit 422 determines whether the remaining amount of points of the user stored in the personal amount-of-points storage unit 433 satisfies the required number of points to be consumed for use of the surveying instrument SI₁ for the specified period.

When the remaining amount of points satisfies the required number of points in Step S504 (Yes), in Step S505, the point consumption unit 424 consumes the remaining amount of points of the user by an amount equal to the required number of points to be consumed, and stores a remaining amount in the personal amount-of-points storage unit 433.

Next, in Step S506, the availability determination unit 422 transmits an answer that the surveying instrument SI₁ is available to the surveying instrument SI₁, and ends the processing.

On the other hand, in Step S503, for example, when the surveying instrument SI₁ is not available for the specified period (No) because the surveying instrument SI₁ has already been used by another user, or in Step S504, when the remaining amount of points is insufficient (No), in Step S507, the availability determination unit 422 transmits an answer of rejection of the use and a warning concerning reasons for rejection of the use (i.e. warning corresponding to reasons for rejection of the use, such as “This apparatus is being used by another user.” or “Points are insufficient.”) to the surveying instrument SI₁, and ends the availability determination processing.

Returning to FIG. 8, in Step S306, when an answer that the surveying instrument SI₁ is available is given from the management server MS (Yes), in Step S307, the use condition (period of use) specified by the user is applied and the surveying instrument SI₁ (instrument) is started, and the processing is ended.

In Step S306, when an answer of rejection of the use is transmitted from the management server MS (No), in Step S308, a warning received from the management server MS is displayed on the display unit 25, and in Step S309, the power supply of the surveying instrument SI₁ is turned OFF and the processing is ended. Alternatively, a configuration can be made so that, previous to turning OFF of the power supply, the processing returns to Step S304 and a use condition can be specified again.

On the other hand, in Step S303, when the surveying instrument is available (Yes) because the expiration date for use has not elapsed since the last use, the processing directly shifts to Step S307, and a use condition (period of use) stored in the management server MS is read out and the apparatus (surveying instrument) is started, and the processing is ended.

### Usage Example

Hereinafter, an example of use for the first time of a total station of the model iX-1001 (hereinafter, referred to as total station TS1) by a user A by using this system 10 including the use management table illustrated in FIG. 5, in May 2019, is described.

The user A made pre-registration for personal authentication, and has a user account with a user ID: T00004. The user A purchased 50 points in advance.

At a storage location of surveying instruments near the site, the user A turns ON the power supply of the total station TS1, and is subjected to personal authentication.

The total station TS1 is not available to the user A because of the user's first time of use, and a screen for inputting a use condition is displayed on the display unit. The user A specifies 6 months as a use condition. The total station TS1 consumes 10 points per month, and when referring to the management server MS for availability, a warning “Your points are insufficient. Add points or shorten the period of use.” is displayed on the display unit 25, and a screen for specifying a use condition is displayed again.

Then, when the user A specifies 5 months, the management server MS determines the total station TS1 to be available, and the total station TS1 is started.

According to the embodiment described above, the surveying instrument includes a personal authentication sensor and a personal authentication execution unit, so that a user can be identified without fail, and management can be easily performed such as management to grasp which user currently uses the corresponding apparatus. In addition, a person who does not have use authority can be prevented from using the surveying instrument.

According to the embodiment described above, the point consumption unit is provided, and when a user uses the apparatus, points that the user purchased in advance are consumed, so that the costs for use of the instrument can be properly collected from a user who uses the instrument without complicated management.

Further, costs can be obtained based on the use management table showing correspondence between information on instruments and the required number of points, and the required number of points is determined according to the type, performance, and a use of period of the apparatus, so that costs can be made appropriate.

Information on the instrument includes use states of other users, so that availability to an identified user can be determined without hindering use of other users.

### Modification 1

As a modification of the embodiment, a surveying instrument may be configured without including the use state check unit 232. A configuration including the use state check unit 232 is advantageous because the surveying instrument can be started without a request to the management server in a case where the surveying instrument has already become available, and accordingly, the surveying instrument can be quickly started, however, this function is not essential.

### Modification 2

As another modification of the embodiment, it is possible that the surveying instrument does not include the use condition settings unit 233, and it is only checked with a user to see if the user has an intention to use in Step S304. In this case, when a use condition is a period of use, and the number of points to be consumed set in the use management table is the number of points to be consumed per month, a configuration may be made so that it is automatically determined that an available period has expired when one month elapses.

A surveying instrument that includes the use condition settings unit 233 so that a use period can be set as a use condition is advantageous because a user can set use authority throughout the entire period of use with one setting. Thereby, the embodiment to achieve the intended effect can be obtained by the configuration described above.

### Modification 3

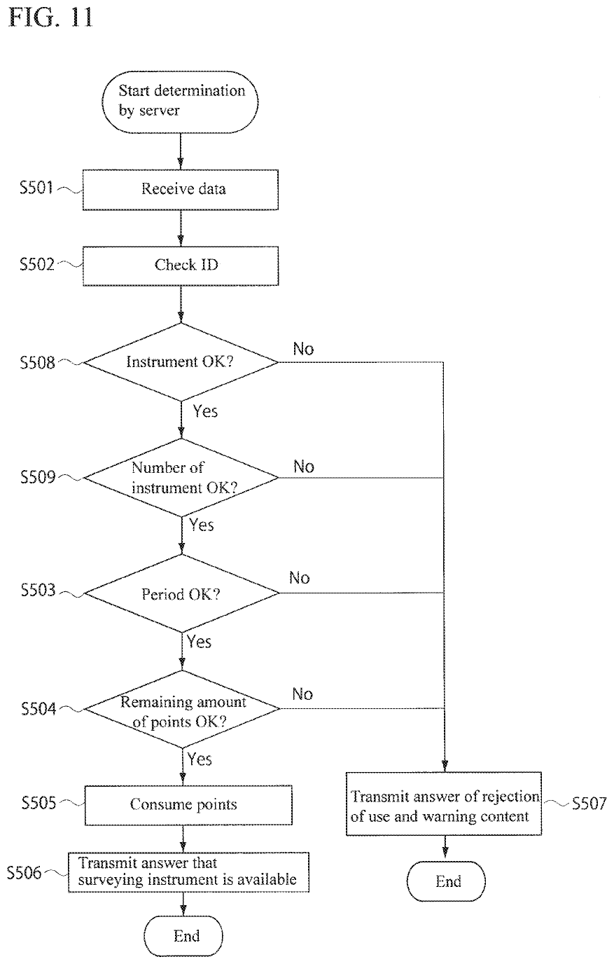

As another modification of the present embodiment, a configuration may be made so that, when a user purchases points, for example, the user determines available models and the number of available instruments in advance, and when availability is determined, as illustrated in FIG. 11, Steps S508 and S509 are added between Step S502 and Step S503 so that determination on a predetermined condition is made.

In other words, in Step S508, the availability determination unit 422 determines whether an instrument that the user intends to use corresponds to the available model determined in advance, and in Step S509, the availability determination unit 422 determines whether the number of instruments used by the user exceeds the number of instruments determined in advance due to the use of the corresponding surveying instrument by referring to the use management table.

Having the capability of setting a plurality of available instruments is advantageous in a case where a user in this system is applied not only to a personal user but also to an administrator such as a company which manages a plurality of surveying instruments. In this case, it is preferable that a configuration enabling a plurality of authentication data to be set for one account is made.

### REFERENCE SIGNS LIST

10 Sharing system (system)
SI₁, SI₂, . . . SIₓ Surveying instrument
RT Remote terminal
MS Management server
N Communication network
21 Measuring unit
23 Control unit
231 Personal authentication execution unit
232 Use state check unit
233 Use condition settings unit
27 Communication unit
41 Server communication unit
42 Server control unit
422 Availability determination unit
424 Point consumption unit
431 Personal identification information database
432 Use management table

What is claimed is:

1. A surveying instrument sharing system comprising:
a surveying instrument including a measuring unit configured to make measurements for a survey, a communication unit, a personal authentication sensor, and a control unit; and
a management server including a server storage unit, a server communication unit, and a server control unit, and capable of communicating with the surveying instrument through a communication network, wherein
the server storage unit includes a personal identification information database having authentication information registered in advance, and a use management table as a correspondence table between information on available surveying instruments and the required number of points,
the control unit of the surveying instrument includes a personal authentication execution unit configured to identify a user from the personal identification information database based on authentication data acquired by the personal authentication sensor,
the server control unit includes an availability determination unit configured to determine whether the surveying instrument is available to an identified user based on the use management table, and a point consumption unit configured to consume the required number of points from points purchased in advance by the identified user based on the use management table, and
the surveying instrument is made available by consumption of the points.

2. The surveying instrument sharing system according to claim 1, wherein
the control unit of the surveying instrument further includes a use condition settings unit for setting a condition specified by the identified user, and
the availability determination unit is configured to determine whether the surveying instrument is available under the specified condition set in the use condition settings unit based on the use management table.

3. The surveying instrument sharing system according to claim 1, wherein the availability determination unit is configured to determine whether the surveying instrument is available based on a predetermined condition.

4. The surveying instrument sharing system according to claim 2, wherein the availability determination unit is configured to determine whether the surveying instrument is available based on a predetermined condition.

5. The surveying instrument sharing system according to claim 1, wherein the control unit of the surveying instrument further includes a use state check unit configured to check whether the surveying instrument has already become available to the identified user.

6. The surveying instrument sharing system according to claim 2, wherein the control unit of the surveying instrument further includes a use state check unit configured to check whether the surveying instrument has already become available to the identified user.

7. A method for sharing a surveying instrument comprising:
a step of identifying a user by a control unit of a surveying instrument including a measuring unit configured to make measurements for a survey, a communication unit, a personal authentication sensor, and the control unit, from a personal identification information database having authentication information registered in advance in a management server capable of communicating with the surveying instrument through a communication network based on authentication data acquired by the personal authentication sensor; and
a step of making available the surveying instrument by consuming the required number of points for use of the surveying instrument by the control unit from points that the identified user purchased in advance in a case where the surveying instrument is determined to be available as a result of determination as to whether the surveying instrument is available to the identified user made by the management server based on a use management table as a correspondence table between information on available surveying instruments and the required number of points.
